(19) United States
(12) Patent Application Publication
(10) Pub. No.: US 2016/0203556 A1
(43) Pub. Date: Jul. 14, 2016

(54) MINIMUM OUTCOME ASSURANCE CONTRACTS FROM REVENUE SHARING OF ROYALTIES

(71) Applicant: Arthur Lipper, III, Del Mar, CA (US)

(72) Inventor: Arthur Lipper, III, Del Mar, CA (US)

(21) Appl. No.: 14/594,732

(22) Filed: Jan. 12, 2015

(51) Int. Cl. G06Q 40/06

(52) U.S. Cl. CPC G06Q 40/06

(57) ABSTRACT

Two new forms of financial instruments that can be offered by an issuing company at an initial public offering via an exchange or investment syndicate or otherwise, and, if used, a computerized exchange for trading. The instruments include Fair Revenue Participation Contracts (FRPC) which provide investors with a right to receive a fixed percentage of the issuing company's revenue for a fixed length of time, in combination with a minimum payment guarantee underwritten by a third party guarantor which guarantees some minimum amount of royalty payments to investor, at least recouping their initial investment or resulting in some higher yield to investors. In addition a Debt+Share Royalty instrument gives investors, in exchange for making a loan, a right to repayment of the loan followed by a fixed percentage of the royalty issuer's revenue pursuant to a fixed payment schedule until a fixed amount of revenue has been paid (e.g., a variable period of time determined by revenues).

### CROSS-REFERENCE TO RELATED APPLICATION(S)

The present application derives priority from U.S. Provisional Patent Application 61/925,599 filed 9 Jan. 2014.

### BACKGROUND OF THE INVENTION

1. Field of the Invention

The present invention relates to an investment and exchange, the investment being neither traditional equity nor debt, but rather a protected royalty right to participate in the revenue of a company, the protection being a minimum payment guarantee product that eliminates the risk of investor principal loss. A method for providing investors with liquidity through an exchange system facilitating the trading in said protected royalty rights is also disclosed.

2. Description of the Background

“Securities” may be broadly defined as investment instruments, other than an insurance policy or fixed annuity, issued by a corporation, government, or other organizations which offers evidence of debt or equity. There are many different types of securities and many exchanges worldwide for trading in them.

Currently, the only way for typical investors to participate in the profitability of a given company is to purchase equity related securities in that company. An equity security is an instrument that signifies an ownership position in a corporation, and represents a claim on its proportional share in the corporation's assets and profits. For example, if a company has 100 shares of stock outstanding and a person owns 10 of them, then he/she owns 10% of the company. Most stock also provides voting rights, which give shareholders a proportional vote in certain corporate decisions. There are also shares which carry super majority voting rights as to certain corporate actions.

Of course, the investor may alternatively purchase a debt security which represents a promise to repay the face value of the security plus an additional amount called interest.

Unfortunately, simple debt and equity securities are not always viable or attractive investment options for all parties. Many entrepreneurs and business owners, when considering their fund raising needs, are reluctant to sell any equity. Yet, those interested in investing in such companies want to own a piece of the company to benefit from the upside growth. On the other hand, early stage companies are generally not able to borrow unless the loans are guaranteed and the guarantors frequently require a fee as an inducement to accept the risk. For closely owned corporations this usually means personal guarantees, for example, leveraging the family home, credit cards and others. Many budding entrepreneurs and business owners are unwilling to compromise their personal assets. Moreover, the positive and negative covenants which are a part of most loans severely restrict the actions of the company.

Applicant's U.S. Pat. No. 7,813,999 issued Oct. 12, 2010 discloses a fair revenue participation contract and exchange that defines a “fair revenue participation contract” (FRPC), that allows investors to participate in revenue rather than profits. The FRPC gives the investor rights to a percentage of the revenues of an issuing company, it being structured as a promise to pay X % of revenues for Y number of years.

A financial mechanism for providing a minimum payment guarantee product by as third party guarantor to an FRPC sold on an exchange would make it much easier for many emerging and family and privately-owned companies to find growth capital. In addition, there is also a need for a Debt+Share royalty participation instrument in which the parties agree on traditional debt financing terms such as the amount of money to be borrowed by the company, the maturity of the loan, the amortization schedule, the interest rate and other terms regarding the loan. Venture debt lenders expect annual returns of 20%-40%+ on their capital but the loan interest necessary to achieve this is or may be hard to bear for early stage business owners. Consequently, the Debt+Share royalty participation instrument adds a royalty-share premium payable as a percentage of the issuing company's revenues after loan repayment. This way the lender is incentivized to accept the risk and compensated for the higher rate of perceived level of risk on these loans by earning incremental returns after loan repayment.

Accordingly, a system and method that addresses these needs is presented herein.

### SUMMARY OF THE INVENTION

It is, therefore, a primary object of the present invention to provide a Fair Revenue Participation Contract (FRPC) by an issuing company in the form of a financial instrument with a minimum payment or Enhanced Royalty Guarantee (ERG) that can be offered in a direct placement with an investor or through an Initial Public Offering via an exchange or an investment syndicate, and an exchange for trading FRPCs.

It is another object to provide a Debt+Share royalty participation instrument by an issuing company in the form of a financial instrument that can be offered in a direct placement or via an exchange or an investment syndicate, and an exchange for trading Debt+Share Royalty products. The minimum payment guarantee (ERG) may or may not be attached to the Debt+Share instrument as well, to secure the royalty-share premium payable as a percentage of the issuing company's revenues after loan repayment and/or the debt repayment itself. The combination of the FRPC and Debt+Share Royalty products give early stage companies an attractive option to traditional equity and debt financing, the FRPC instrument providing a guaranteed minimum amount of royalty payments to investors, at least recouping their initial investment, or resulting in some higher yield to investors, and the Debt+Share Royalty product providing a lesser revenue sharing during the lifetime of the repayment period.

### BRIEF DESCRIPTION OF THE DRAWINGS

Other objects, features, and advantages of the present invention will become more apparent from the following detailed description of the preferred embodiments and certain modifications thereof when taken together with the accompanying drawing in which:

FIG. 1 is a diagram of the exchange format inclusive of the principal participants according to a preferred embodiment of the present invention.

### DETAILED DESCRIPTION OF THE PREFERRED EMBODIMENTS

The present invention combines a Fair Revenue Participation Contract (FRPC) that allows investors to participate in revenue rather than profits, with a Debt+Share Royalty product, the combination giving early stage companies an attractive option to traditional equity and debt financing.

The FRPC instrument allows investors to participate in revenue rather than profits, but adds a minimum payment guarantee by which the investor is guaranteed to receive royalty payments at least equal the investor's original investment. Optionally, the FRPC may have an enhanced payment guarantee by which the investor is guaranteed to receive some higher minimum cumulative royalty payments resulting in a yield to original investors. The minimum and/or enhanced payment guarantees are products underwritten by a third party guarantor. This provides a guaranteed minimum amount of royalty payments to investors, at least recouping their initial investment, or resulting in some higher yield to investors.

The Debt+Share Royalty product provides investors with a lesser revenue sharing during the lifetime of the repayment period while allowing business owners to obtain a loan at an acceptable interest rate without the risks associated with debt financing of privately owned companies, such as personal guarantees or positive and negative covenants.

An Exchange for trading the FRPCs and Debt+Share Royalty products is also disclosed.

The guaranteed FRPC investment and Debt+Share Royalty instruments have substantial public benefit inasmuch as they give fledgling and privately-owned companies access to additional capital without suffering equity dilution or debt, and the revenue focus will allow them, subject to exchange or government regulations, to keep their profitability confidential. This also gives larger and possibly already publicly traded companies access to capital specifically focused on designated projects or areas of activities. The guaranteed FRPC product is attractive to investors because it allows a growing return based on success of a company rather than a fixed interest return, and yet avoids uncertainty of return based on profits. Moreover, the guaranteed FRPC lends itself to active trading because the FRPCs can be offered at an initial public offering via an investment syndicate, and then traded on the exchange. Moreover, the revenue focus is attractive to underwriters and brokers, thereby facilitating the mobilization of capital. Of course, even 5% of revenues may be a heavy burden for the company if the projected profits do not materialize since the FRPCs represent a fixed cost to the company (even though there is no equity dilution such payments can be a burden). It can be an equally heavy burden to the investor since the FRPC can be a speculative investment vehicle. To increase the investment quality and liquidity of the FRPC the present invention adds a minimum payment guarantee product. This Minimum/Enhanced Royalty Guarantee (ERG) provides a guarantee to an FRPC holder that they will receive some minimum return of the purchase price.

The Debt+Share Royalty product provides debt-based financing based on traditional terms, e.g., an agreed amount of money to be borrowed, loan maturity, amortization schedule, interest rate, and any other desired terms regarding the loan. In addition, the parties negotiate a royalty premium payable after loan repayment as a percentage of revenues. The revenue sharing royalty can be for a negotiated percentage of the revenues of the royalty issuing company for as many years as agreed, following loan repayment. In this case, the percentage of revenues paid to the lender are substantially less than with FRPCs (where the original funds are not loaned and risk to capital is higher). Nevertheless, debt-based funding is more attractive to early-stage investors with this continuing royalty-share premium. This effectively allows business owners to obtain a loan at an acceptable interest rate without the risks associated with debt financing of privately owned companies, such as personal guarantees of repayment or positive and negative covenants.

As described below, the minimum payment guarantee (ERG) described above relative to the FRPCs may optionally be attached to the premium royalty-share payments made in the Debt+Share instrument and/or the debt repayment as well. The FRPC, ERG, and Debt+Share royalty products as well as an exemplary trading exchange are herein described in detail below.

1. FRPC Product

The FRPC itself is a contractual right sold to an investor to receive a fixed percentage of a company's revenue for a fixed length of time. Each FRPC is a written contract under which an issuing company agrees to pay a specified percentage of its revenue (as distinct from profits) over a specified period of time to investors who have purchased FRPC revenue participation rights from it, or their assignees (the FRPC Holders). “Revenue” is strictly defined as the gross amount of income received by the issuing company, its subsidiaries, affiliates and related parties (collectively, the Group) for the sale of goods and services in respect of all their commercial activities. The FRPC is structured as an issuer's promise to pay the investor X % of revenues for Y number of years. Thus, in an initial offering there are three things to negotiate: 1) a percentage of revenues to be paid to the investor; 2) a length of time that the agreed percentage of revenues is to be paid to the investor; and 3) the amount of capital paid by the investor for the FRPC(s). As an example, an exemplary FRPC may be structured to give an investor 5% of revenue over twenty years, in return for a $10M investment. Consequently, if a company and/or entrepreneur is confident in their revenue projections they can obtain funds without having to reduce their equity percentage in the company.

2. The Minimum/Enhanced Royalty Guarantee (ERG).

Each ERG is a written guarantee applicable and may be attached to an FRPC under which a third party guarantor agrees to indemnify the FRPC holder if the actual percentage of revenue over the specified period of time fails to exceed the annuitized value of the purchase price, or alternatively, some higher guaranteed minimum cumulative amount of royalty payments made by the FRPC issuer. More specifically, this minimum payment guarantee product is a contract between the FRPC issuer and a third party guarantor, with the investor as a third party beneficiary. The FRPC issuer's commitment to pay the third party guarantor a percentage of the FRPC revenue that accrues to the investor over the life of the FRPC may be structured as a “royalty premium” which is a fixed percentage (X %, e.g., 8%) of the royalty amounts that accrue to the investor under the FRPC, until the investor's original investment is fully repaid. The governing Exchange requires the issuer to purchase at least the minimum payment guarantee product, although as described above this requirement may be fulfilled with the enhanced payment guarantee product. All else being equal, the enhanced payment guarantee product guarantees payment of some higher guaranteed minimum cumulative amount of royalty payments made by the FRPC issuer (more than the investor's original investment) in exchange for some higher fee, which may be to fixed percentage of the royalty amounts, the differences to be negotiated between the third party guarantor and FRPC issuer. The third party guarantor may negotiate other considerations as well. For example, their acceptance of financial risk and the service(s) provided to the FRPC issuer and the exchange may suffice as consideration for negotiated exclusivity, by which the third party serves as exclusive guarantor for FRPC offerings made on or through the exchange.

The following is an example of the terms and conditions of a minimum payment guarantee instrument to be issued by the third party guarantor in exchange for the FRPC issuer's payment of a surcharge of X % of the royalties payable to the FRPC Holder:

| | |
|---|---|
| Guarantor | A company incorporated in [•]. |
| Guarantee | For X % of the royalties accrued under the FRPC the FRPC |
| | issuer may purchase the minimum payment guarantee ensuring |
| | on the FRPC holder's behalf that a minimum amount of |
| | royalty payments will be made within the royalty payment |
| | period, e.g., Minimum Guarantee of $[ ] in |
| | cumulative royalty payments over [ ] years and |
| | expiring [ ]. |
| Security | [Description of Assets] If necessary, the third party |
| | guarantor will bold the security. |

Note that the guarantor has no liability until the end of the royalty payment period and this liability is reduced by every royalty payment made by the issuer.

3. Debt+Share Royalty Product

Each Debt+Share Royalty product is a written contract under which the issuing company agrees to traditional debt financing terms including loan amount, loan structure, interest rate, fees, term, amortization, prepayment terms, and any other desired terms regarding the loan. In addition, the parties negotiate a royalty premium payable after loan repayment as a percentage of revenues. This revenue sharing royalty will typically be a negotiated percentage of the revenues of the royalty issuing company payable for as many years as agreed, beginning after loan repayment. Once the loan has been fully repaid the investor has no further risk of capital loss and is therefore willing to accept a much smaller share of the company's revenues as an inducement to making the loan than would have been the case were the original funds being solely based on revenues. On the other hand, the issuing company is advantaged by being able to attract funds with a lesser revenue sharing during the course of the royalty payment period and the investor is served by having a full return of capital in a defined period and with an agreed return. The Debt+Share contract is structured as a traditional loan with the addition of the issuer's promise to pay the investor X % of its revenues pursuant to a predetermined payment schedule (quarterly, semi-annual, etc.) for a negotiable time period beginning after the debt has been fully extinguished. Thus, in an initial offering there are three things to negotiate in addition to traditional loan and royalty agreement compliance terms: 1) a percentage of revenues to be paid to the investor and payment schedule (to commence after the debt has been fully extinguished; 2) the number and/or duration of royalty-share payments. As an example, if we assume that an issuing company enjoys current revenue of $20.0M annually and seeks a loan of $10M (limited to 50% of current revenue), the parties may negotiate a $10.0M loan with a maturity at 5 years, payable with interest (paid from commencement) of 12% amortized monthly over 60 equal monthly payments. Given these terms, the parties may additionally negotiate a revenue-sharing royalty of 1% to be paid on the revenues in excess of those at time of loan payable monthly for fifteen years after loan repayment. This way, if a company and/or entrepreneur is confident in their revenue projections they can obtain funds without having to reduce their equity percentage in the company.

One skilled in the art will understand that the foregoing Minimum/Enhanced Royalty Guarantee (ERG) may be attached to secure the revenue-sharing royalties of Debt+Share Royalty product similar to the FRPC, and/or to secure the debt repayment itself. For the former each Debt+Share ERG would be a written guarantee under which a third party guarantor agrees to indemnify the Debt+Share holder if the actual percentage of revenue over the specified period of time fails to exceed some guaranteed minimum cumulative amount of royalty payments made by the Debt+Share issuer. Of course, the need for this is not so pronounced because the original loan will have already been repaid and so capital risk is lower. To secure the debt repayment each Debt+Share ERG written guarantee would additionally include a third party guarantee of indemnity to the Debt+Share holder if the issuing company defaults on the loan payments.

4. The Royalty Entitlement Exchange (REE)

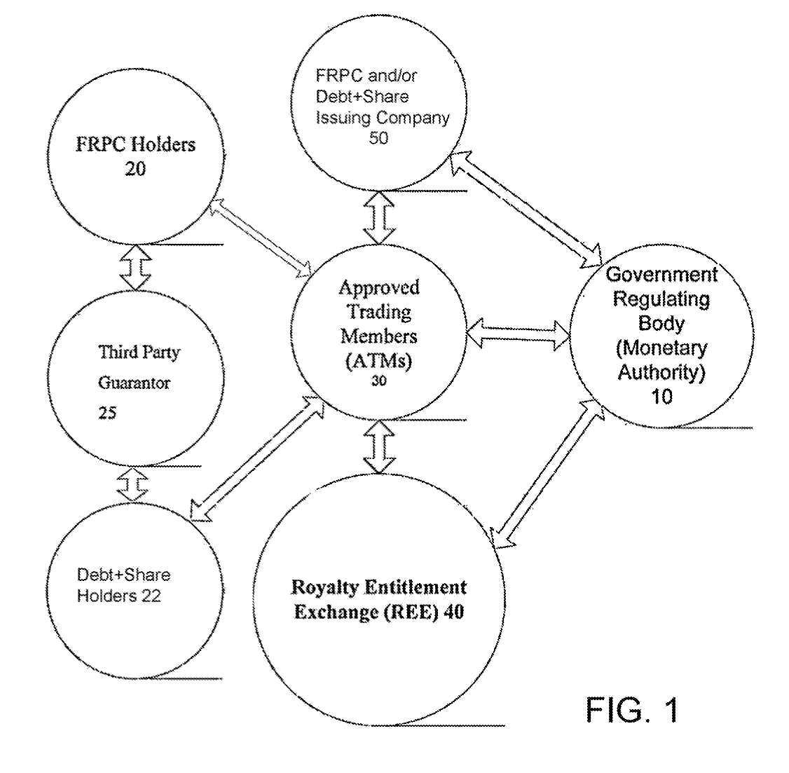

FIG. 1 is a diagram of the exchange format inclusive of the principal participants, which include the investors (FRPC Holders 20 and Debt+Share Holders 22), Approved Trading Members (ATMs 30), a Government Regulating Body (GRB) for regulating the exchange, the FRPC and/or Debt+Share Issuing Company 50, the third party guarantor 25, and the Royalty Entitlement Exchange (REE) 40 itself.

In operation, each FRPC and/or Debt+Share Issuing Company 50 will negotiate directly with the exchange or with underwriters who must be pre-qualified ATMs 30, qualified in accordance with the regulations promulgated by the exchange and/or a Government Regulating Body.

For FRPCs, the ATMs 30, acting as underwriter(s), will negotiate the percentage of revenues to be paid to the FRPC Holders 20 for each FRPC unit, the FRPC lifetime (length of time that the agreed percentage of revenues is to be paid to the FRPC Holders 20), and the amount of capital paid by FRPC Holders 20 for each FRPC(s). Initially, each contractual Unit of FRPC (“Unit”) will be assigned a value based on these negotiations (for example, US$10,000 in initial face value), and this face value represents the FRPC Holder's 20 initial investment for each unit. The FRPC-issuing company 50 then negotiates directly with the third party guarantor 25 the royalty premium (percentage of royalties X %) to be paid to the third party guarantor 25 for the minimum payment guarantee, and the lifetime of the minimum payment guarantee (which may or may not be the same as the FRPC lifetime). The result is an investor protection contact between FRPC-issuing company 50 and third party guarantor 25 that guarantees minimum payment to the FRPC investor 20 in apportioned over the lifetime of the minimum payment guarantee. This third-party beneficiary contract guarantees to the investor 20 that the cumulative royalty payments that accrue under the FRPC shall at least equal the original amount paid for the FRPC by the investor 20. Alternatively, the FRPC-issuing company 50 may negotiates directly with the third party guarantor 25 for an enhanced payment guarantee of some higher guaranteed minimum cumulative amount of royalty payments made by the FRPC issuer, thereby effectively increasing the “yield” to the original investor (yield requires a known cost basis which exists for original investors, but the costs basis may rise or fall upon subsequent trades). Based on the minimum/enhanced payment guarantee the FRPC-issuing company 50 may then renegotiate with ATMs 30, acting as underwriters, for a reduced percentage of revenues to be paid to the FRPC Holders 20 for each FRPC unit, or a reduced FRPC unit face value to be paid by FRPC Holders 20 for each FRPC. The ATM(s) 30 who underwrite the initial sale of FRPCs are also responsible to assist the Issuing Company 50 in the preparation of an Information Memorandum similar to a prospectus used in securities offerings, and will then procure investors to purchase the issuing company's 50 underwritten FRPC contractual units, thereby becoming FRPC Holders 20. The FRPC Holders 20 then purchase the FRPC units at face value. They may be issued FRPC certificates representing each contractual unit held. It is noteworthy that the physical FRPC certificates can be held by a depository in a standard manner if secondary trading is effected through book entry mechanism. It is also noteworthy that each “Certificate” may be scriptless to allow trading without the transfer of a physical certificate. After the initial offering, all FRPC contractual units are subject to secondary trading on the Royalty Entitlement Exchange 40 or a section of another existing exchange. Toward this end, any qualified ATM 30 may act as a principal or serve as a buyer's and/or seller's agent. FRPC certificates may be freely traded between buyer ATMs 30 and seller ATMs 30. The ATM 30 acting on behalf of the seller must procure a written assignment of the FRPC from the seller and give notice of the assignment to the issuing company 50 (or its agent) and guarantor 25. With each successive royalty payment from FRPC Holder 20 to FRPC Issuer 50, the potential liability of the third party guarantor 25 is reduced, until the cumulative payment of an amount at least equal to the face value of the FRPC (the total amount paid by the investor for the FRPC), at which point the potential liability is eliminated and the minimum payment guarantee product expires. Each component of the FRPC instrument and exchange is described in more detail below.

For Debt+Share products, the ATMs 30 will negotiate the maturity, amortization, interest rate and collateralization of the debt plus the terms of the royalty percentage of revenues to be paid to the Debt+Share Holders 22 for each Debt+Share unit (the latter including the revenue-share royalty amount, payment schedule commencing upon repayment of the loan, and duration or number of revenue-share royalty payments to be paid to Debt+Share Holders 22 for each unit). The ATMs 30 may also optionally negotiate the ERG guarantee with a third party guarantor. The ATM(s) 30 who conduct the initial sale of Debt+Share units are also responsible to assist the Issuing Company 50 in the preparation of an Information Memorandum similar to a prospectus used in securities offerings, and will then procure investors to purchase the issuing company's 50 underwritten Debt+Share contractual units, thereby becoming Debt+Share Holders 22. The Debt+Share Holders 22 then purchase their units and are issued Debt+Share certificates representing each contractual unit held. After the initial offering, all Debt+Share contractual units are subject to secondary trading on the Royalty Entitlement Exchange 40 or a section of another existing exchange. Again, any qualified ATM 30 may act as a principal or serve as a buyer's and/or seller's agent.

A salient aspect of the REE 40 is that it is owned and operated by the government or by investor owners of the Exchange 40 or the member ATMs 30, operating under regulation of a Government Regulating Body (GRB). Existing exchanges are now mostly for-profit and publicly traded companies, where the “members” are essentially customers of the exchange. In this case, subject to GRB approval, the REE 10 will be established as a company incorporated in the locale of the exchange. It will have as ATMs 30 broking houses and other financial service institutions approved by GRB (they must also be holders of appropriate broker licenses). Each ATM 30 will be accorded a membership or “seat” on the REE 40, represented by their holding of one membership share in the REE 40. The membership shares of REE 40 shall be accorded equal votes. However, in some countries, e.g., China, the government owns the stock exchanges. The present invention encompasses this scenario as well.

It is envisioned that FRPC units and Debt+Share units will be just two products that may be traded on the REE Exchange 40, and that only ATMs 30 will be entitled to trade on the REE 40. This way, ATMs 30 will have to comply with all REE 40 trading rules and by-laws, and all such rules must be approved by ATMs 30 and the GRB. The REE 40 will operate trading and clearing facilities for the products traded on it, inclusive of the FRPCs, and will charge listing and transaction fees. To promote the effective and efficient control of risks to investors and FRPC holders 50, as well as market integrity and financial stability that may arise from the operation of an exchange-operated, screen-based trading system for derivative products that operate with direct access participants from multiple jurisdictions (‘cross-border markets’), the GRB will adhere to the following additional principles.

A. The GRB will develop cooperative arrangements and coordinate supervisory responsibilities, consistent with each ATM's 30 responsibilities in a manner that promotes regulatory effectiveness and avoids the imposition of unnecessary regulatory costs.

B. The GRB and all ATMs 30 will share relevant information in an efficient and timely manner, identifying in advance the information needed, the sources of that information, the manner in which the information can be obtained and the channels through which it can be shared. The presently-envisioned information needed for proper operation is detailed below.

C. The applicable regulatory requirements in the jurisdiction of the GRB and the ATMs 30 should be transparent.

There are a number of suitable trading platforms, operating systems and hardware available to provide the requisite functionality. Many investors and traders prefer a screen based trading (SBT) system for its transparency and ease of use, and this is a good choice for the REE 40. There are several screen-based trading applications available on the commercial market, including Microsoft™ software solutions using a Microsoft BackOffice™, platform including Windows NT, SQL Server and MS exchange with a custom front end interface.

5. The Government Regulating Body (GRB)

The GRB may choose to approve a ruleset to be observed by FRPC and/or Debt+Share issuing companies 50 to ensure prompt disclosure of material information and regulation of related party transactions. These issuing companies 50 will also have to submit to director annual audit inspection. Certain disclosure information will be made available via the exchange platform to all ATM 30 members of the REE 40, and to a lesser extent other non-members of the public (ATM 30 members will likely receive more detailed information related to prior transactions. There will also be requirements for Issuers 50 to make information available within certain time frames. The specific details of disclosure will be determined by the Exchange 50. ATM 30 members must be able to input and receive data instantaneously. Some of this data is fixed, subject to administration initial and updating input, and some dynamic and transaction based. The present invention also encompasses the scenario where no GRB is involved.

It should now be apparent that the present invention provides an investment instrument with guaranteed investor protection contact, and exchange platform therefor, which take full advantage of a selling syndicate, wherein the inclusion of a selling charge into the price of the investment instruments does not upset the relationship between the price of the instruments and their face value. The new FRPC (with minimum payment guarantee) and Debt+Share products, and REE exchange will encourage new capital markets and make it much easier for emerging companies to find growth capital.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. An exchange traded or directly placed investment instrument comprising:
a Debt+Share Royalty product for allowing investors to participate in revenue of an issuing company consisting of transferable contractual rights (Units, which may be evidenced by certificates) sold to a holder of the Debt+Share Royalty product in exchange for a loan to said company, plus a right to receive a fixed percentage of the issuing company's revenue paid over a predetermined payment schedule beginning upon repayment of said loan.

2. An exchange traded investment instrument comprising:
a Fair Revenue Participation Contract (FRPC) for allowing investors to participate in revenue of an issuing company consisting of a transferable contractual right (Units, evidenced by certificates) sold to a holder of the FRPC in exchange for an initial investment, for a right to receive a fixed percentage of the issuing company's revenue for a fixed length of time;
a contract between said issuing company and a third party guarantor by which said third party guarantor guarantees that said fixed percentage over said fixed length of time is equal to or greater than the FRPC holder's initial investment.
